(19) United States
(12) Patent Application Publication
(10) Pub. No.: US 2026/0055628 A1
(43) Pub. Date: Feb. 26, 2026

(54) INFLATABLE SWIMMING POOL

(71) Applicant: Intex Marketing Ltd., Tortola (VG)

(72) Inventors: Ai Ming Tan, Fujian (CN); Zhi Xiong Huang, Fujian (CN); Wen Xiao Zhang, Fujian (CN)

(73) Assignee: Intex Marketing Ltd., Tortola (VG)

(21) Appl. No.: 19/105,438

(22) PCT Filed: Aug. 23, 2023
(86) PCT No.: PCT/IB2023/058367

§ 371 Date: Feb. 21, 2025

(30) Foreign Application Priority Data
Aug. 23, 2022 (CN) 202222222755.9
Jul. 12, 2023 (CN) 202321819107.X

(51) Int. Cl. E04H 4/00; A61H 33/00; E04H 4/12; E04H 4/14

(52) U.S. Cl. CPC E04H 4/0025; A61H 33/005; A61H 33/0091; E04H 4/148; A61H 2033/0083; A61H 2201/0103; A61H 2201/5007; E04H 4/1245; E04H 4/129

(57) ABSTRACT

An integrated connection device may connect a controller to a swimming pool that may include one or more features requiring electricity. The integrated connection device may include an air passageway and an electrical conductor. Thus, the integrated connection device may transport air to the swimming pool and at least partially conceal the electrical conductor that connects the one or more electrical features to the controller.

### RELATED APPLICATIONS

This application is related to Chinese Application No. 202222222755.9, filed Aug. 23, 2022, and Chinese Utility Model No. CN 202321819107.X, filed Jul. 12, 2023, the entire disclosures of which are expressly incorporated herein by reference.

### FIELD OF THE DISCLOSURE

The present disclosure relates to an integrated air passage and electrical connection structure.

### BACKGROUND OF THE DISCLOSURE

For swimming pools, in particular spa pools, it may be desired to inject air into the water cavity of the pool to produce massaging bubbles. A side wall of the swimming pool may be fused or otherwise connected with an air outlet pipe, and a controller of the swimming pool may be connected to the air outlet pipe through an air inlet pipe to provide massaging bubbles to the water cavity of the pool or spa through the air outlet pipe.

In addition to providing massaging air bubbles, it may be desirable for the spa swimming pools to include additional functions, such as lighting features and other electrical equipment, which may need to be electrically connected to the control box through wiring or other conductors. Exposed electrical wiring may be undesired.

### SUMMARY OF THE DISCLOSURE

In an exemplary embodiment, the present disclosure provides an integrated connection structure, which may complete both an air passage connection and an electrical connection between an external controller and an inflatable pool or spa.

In another exemplary embodiment, the present disclosure provides an inflatable pool, which may include an inflatable pool body and a luminous device coupled to an outer surface of a bottom wall of the inflatable pool body.

In one form thereof, an inflatable pool may comprise an inflatable pool body, a controller releasably coupled to the inflatable body, and a luminous device. The inflatable pool body may include an inner side wall, an outer side wall disposed around the inner side wall, a top wall connected to a top of the inner side wall and a top the outer side wall, and a bottom wall connected to a bottom of the inner side wall and a bottom of the outer side wall. The luminous device may include a luminous strip coupled to a bottom side of the bottom wall, and the luminous device may be coupled to the controller to receive electrical power from the controller. The bottom wall may include a light-transmitting material.

In another form thereof, the luminous strip may be disposed in a ring shape on the bottom side of the bottom wall of the inflatable pool body, and the luminous strip may be opposite the top wall of the inflatable pool body, and the inner side wall of the inflatable pool body may include a light-transmitting material.

In another form thereof, the top wall of the inflatable pool body may include a light-transmitting material.

In another form thereof, the outer side wall of the inflatable pool body may include a light-transmitting material.

In another form thereof, the bottom wall of the inflatable pool body may be coupled to at least one fixing piece, and a fitting channel for housing the luminous strip may be formed between the fixing piece and the bottom wall.

In another form thereof, the controller may include an air pump to provide air to the inflatable body and a water pump to provide water to the inflatable body.

In another form thereof, the controller may include an electrical power supply, an air pump, and an inlet pipe component, the inlet pipe component may include a first electrical connection terminal connected to the electrical power supply and an inlet air passageway connected to the air pump. The inflatable pool body may include an outlet pipe component for connecting to the inlet pipe component, the outlet pipe component may include a second electrical connection terminal electrically connected to the luminous strip and an outlet air passageway in fluid communication with an inflatable air chamber of the inflatable pool body, the second electrical connection terminal may be configured to couple to the first electrical connection terminal of the inlet pipe component, and the outlet air passageway may be configured to fluidly couple to the inlet air passageway.

In another form thereof, the outlet pipe component may be coupled to the outer side wall of the inflatable pool body.

In another form thereof, the second electrical connection terminal of the outlet pipe component may be electrically connected to the luminous strip via a connecting wire.

In another form thereof, the luminous strip may be a flexible LED strip.

In another exemplary embodiment, the present disclosure may provide an integrated structure for connecting an air passage and a circuit comprising an outlet pipe component, an inlet pipe component, and a joint configured to connect the outlet pipe component to the inlet pipe component. The outlet pipe component may comprise a first face and a first air passage extending along an axis that intersects the first face, and a first electrical connection terminal positioned proximate the first face. The inlet pipe component may comprise a second face facing the first face of the outlet pipe component, a second air passage configured to fluidly connect to the first air passage of the outlet pipe component, and a second electrical connection terminal positioned proximate the second face and configured to connect to the first electrical terminal. When the joint connects the outlet pipe component to the inlet pipe component, the first air passage of the outlet pipe component and the second air passage of the inlet pipe component may connect to form an air passage connection extending from the air inlet pipe component through the outlet pipe component, and the first electrical connection terminal of the outlet pipe component may couple to the second electrical connection terminal of the inlet pipe component to form an electrical connection therewith.

In another form thereof, the joint may comprise threads and may be sleeved at one end of the inlet pipe component facing the outlet pipe component, and an outer wall of the outlet pipe component may be externally threaded and configured to threadably engage with the threads of the joint.

In another form thereof, the second electrical connection terminal of the inlet pipe component may be a power female connector and the first electrical connection terminal of the outlet pipe component may be a power male connector.

In another form thereof, the inlet pipe component may comprise an inlet pipe, a rotating component, and a connecting ring, and the rotating component may be rotationally connected to the end of the inlet pipe facing the outlet pipe component through the connecting ring.

In another form thereof, an outer wall of the inlet pipe may be provided with a limit groove extending partially along the circumference of the outer wall, and the connecting ring may comprise a clamp block that fits within the limit groove, and the limit groove may limit the rotation range of the clamp block.

In another form thereof, the connecting ring may be divided into a semicircular first connecting ring, which may comprise a first clamp block, and a semicircular second connecting ring, which may comprise a second clamp block, the first connecting ring and the second connecting ring may be connected to form a clamping space for clamping the inlet pipe.

In another form thereof, the integrated structure may comprise at least one limit groove, the limit groove may be rotatably matched with the first clamping block of the first connecting ring and the second clamping block of the second connecting ring.

In another form thereof, an air pump may comprise an air pump body and the integrated structure for connecting an air passage and a circuit as described above.

In another form thereof, a swimming pool may comprise the air pump as described above.

In another form thereof, the swimming pool is a SPA swimming pool.

In another form thereof, the present disclosure may provide an integrated connection device configured to connect a controller to an inflatable pool having an air cavity and a water cavity. The integrated connection device may comprise an inlet pipe coupled to the controller, an outlet pipe including a portion positioned between the inlet pipe and the inflatable pool, and a joint configured to couple the inlet pipe to the outlet pipe. The inlet pipe may comprise an inlet air passageway and an inlet electrical conductor positioned at least partially within the inlet pipe. The outlet pipe may comprise an outlet air passageway and an outlet electrical conductor positioned at least partially within the outlet pipe. The inlet air passageway may be coupled to the outlet air passageway when the joint couples the inlet pipe to the outlet pipe.

In another form thereof, the inlet electrical conductor may be electrically coupled to the outlet electrical conductor when the joint couples the inlet pipe to the outlet pipe.

In another form thereof, the inlet pipe may further comprise a rotating component rotatably coupled to an end of the inlet pipe facing the outlet pipe, and a connecting ring may be configured to couple the rotating component to the inlet pipe.

In another form thereof, a first end of the inlet electrical conductor is accessible from an exterior of the rotating component.

In another form thereof, the rotating component may comprise a portion of the inlet air passageway of the inlet pipe and a separate electrical passageway which receives the electrical conductor.

In another form thereof, the inlet pipe may further comprise a groove, and the connecting ring may comprise a block configured to be positioned within the groove of the inlet pipe, the block of the connecting ring may limit the rotation of the rotating component relative to the inlet pipe.

In another form thereof, the inlet pipe may further comprise a first electrical connection terminal disposed in the inlet pipe, and the outlet pipe may further comprise a second electrical connection terminal disposed in the outlet pipe. The first electrical connection terminal may be configured to couple to the second electrical connection terminal.

In another form thereof, the outlet pipe may further comprise an electrical conductor outlet. The electrical conductor outlet may be positioned within the air cavity of the inflatable pool.

In another form thereof, the outlet pipe may further comprise an electrical conductor outlet, and the electrical conductor outlet may be positioned outside of the air cavity of the inflatable pool.

In another form thereof, the inlet air passageway may be fluidly isolated from the inlet electrical conductor.

In another form thereof, the outlet air passageway may be fluidly isolated from the outlet electrical conductor.

In another form thereof, the inlet air passageway of the inlet pipe may comprise a first inlet air passageway and a second inlet air passageway.

In another form thereof, the first inlet air passageway may be in fluid communication with the air cavity of the inflatable pool, and the second inlet air passageway may be in fluid communication with the water cavity of the inflatable pool.

In another form thereof, the outlet air passageway of the outlet pipe may comprise a first outlet air passageway and a second outlet air passageway.

In another form thereof, the first outlet air passageway may be in fluid communication with the air cavity of the inflatable pool, and the second outlet air passageway may be in fluid communication with the water cavity of the inflatable pool.

In another form thereof, the inlet air passageway of the inlet pipe may comprise a first inlet air passageway and a second inlet air passageway, and the outlet air passageway of the outlet pipe may comprise a first outlet air passageway and a second outlet air passageway, the first inlet air passageway may be in fluid communication with the first outlet air passageway, and the second inlet air passageway may be in fluid communication with the second outlet air passageway.

In another form thereof, the first inlet air passageway and the first outlet air passageway may be in fluid communication with the air cavity of the inflatable pool, and the second inlet air passageway and the second outlet air passageway may be in fluid communication with the water cavity of the inflatable pool.

In another form thereof, the present disclosure may provide an inflatable pool. The inflatable pool may comprise an inflatable body, a controller including an air pump and an electrical power supply, at least one electrically powered accessory, and a conduit connecting the controller to the inflatable body. The inflatable body may have an inner wall and an outer wall, the inner wall may bound a water cavity of the inflatable pool, and the inner wall and the outer wall may bound at least a portion of an inflatable chamber of the inflatable body. The conduit may include an air passageway coupling the air pump to the inflatable chamber of the inflatable body and an electrical conductor electrically coupling the at least one electrically powered accessory to the electrical power supply.

In another form thereof, the conduit may comprise an inlet pipe, an outlet pipe, and a joint coupling the inlet pipe to the outlet pipe, the inlet pipe may comprise an inlet end coupled to an outlet of the air pump.

In another form thereof, the inlet pipe may further comprise a first inlet air passageway and a second inlet air passageway, and the outlet pipe may comprise a first outlet air passageway in fluid communication with the first inlet air passageway and a second outlet air passageway in fluid communication with the second inlet air passageway, the first inlet air passageway, the second inlet air passageway, the first outlet air passageway, and the second air outlet passageway may collectively define the air passageway of the conduit.

In another form thereof, the first inlet air passageway and the first air outlet passageway may be in fluid communication with the inflatable chamber of the inflatable pool, and the second inlet air passageway and the second air outlet passageway may be in fluid communication with the water cavity of the inflatable pool.

In another form thereof, the inlet pipe may further comprise an inlet electrical passageway, and the outlet pipe may comprise an outlet electrical passageway, the electrical conductor passing through the inlet electrical passageway and the outlet electrical passageway.

In another form thereof, the inlet pipe may further comprise a first electrical connection terminal disposed within the inlet pipe, and the outlet pipe may further comprise a second electrical connection terminal disposed within the outlet pipe, the first electrical connection terminal and the second electrical connection terminal may have cooperating features which may be coupled together when the inlet pipe is coupled to the outlet pipe.

In another form thereof, the at least one electrically powered accessory may be positioned within the inflatable chamber, and the electrical conductor may be accessible from an exterior of the outlet pipe at a location within the inflatable chamber.

In another form thereof, the at least one electrically powered accessory may be positioned external to the inflatable chamber and adjacent an exterior surface of the inflatable body, and the outlet pipe may further comprise an electrical conductor outlet positioned outside of the inflatable chamber of the inflatable body and configured to connect to the at least one electrically powered accessory.

In another form thereof, the inlet pipe may further comprise a rotating component rotatably coupled to an end of the inlet pipe facing the outlet pipe, and a connecting ring configured to couple the rotating component to the inlet pipe.

In another form thereof, the electrical conductor may be at least partially disposed within the rotating component.

In another form thereof, the rotating component may comprise an opening configured to receive the electrical conductor.

In another form thereof, the inlet pipe may further comprise a groove, and the connecting ring may comprise a block configured to be positioned within the groove of the inlet pipe, the block of the connecting ring may limit the rotation of the rotating component relative to the inlet pipe.

In another form thereof, the at least one electrically powered accessory may be a lighting system, optionally including at least one LED strip including a plurality of LED lights.

In another form thereof, the lighting system may be positioned adjacent to an exterior surface of a bottom wall of the inflatable pool and optionally received in at least one sleeve.

In another form thereof, the lighting system substantially spans a perimeter of the inflatable pool.

In another form thereof, the lighting system may be coupled to the bottom wall of the inflatable pool via at least one fixed piece.

In another form thereof, the lighting system may be positioned within the inflatable chamber of the inflatable body.

The present disclosure has the following beneficial effects, among others:

The present disclosure provides an integrated structure for connecting an air passage and a circuit. By positioning electrical connection terminals on the air outlet pipe component and the air inlet pipe component, the air outlet pipe component and the air inlet pipe component can also be electrically connected when the air passage is connected.

Additional features and advantages of the present disclosure will become apparent to those skilled in the art upon consideration of the following detailed description.

### BRIEF DESCRIPTION OF THE DRAWINGS

FIG. 1 is a perspective view of an inflatable spa including an integrated structure for connecting an air passage and a circuit according to the present disclosure;

FIG. 2 is cross-sectional view of the inflatable spa of FIG. 1 including the integrated structure of FIG. 1;

FIG. 3 is a schematic view depicting the relationship between the inflatable spa, the integrated structure, and a controller;

FIG. 3A is a schematic view of a first arrangement of the inflatable spa, portions of the controller, and the integrated structure of FIG. 3;

FIG. 3B is a schematic view of a second arrangement of the inflatable spa, portions of the controller, and the integrated structure of FIG. 3;

FIG. 4 is an exploded view of the integrated structure of FIG. 1;

FIG. 5 is an exploded view of the integrated structure of FIG. 1;

FIG. 6 is a perspective view of the integrated structure of FIG. 1;

FIG. 7 is a cross-sectional view of the integrated structure of FIG. 1 depicted in a disconnected state;

FIG. 8 is a cross-sectional view of the integrated structure of FIG. 1 depicted in a connected state;

FIG. 9 is a perspective view of an inflatable spa including an embodiment of the integrated structure of the present disclosure;

FIG. 10 is a bottom perspective view of the inflatable spa of FIG. 9 including the integrated structure of FIG. 9;

FIG. 10A is top perspective view of the inflatable spa including an exemplary integrated structure;

FIG. 10B is a perspective view of the inflatable spa of FIG. 10A including an exemplary controller;

FIG. 11 is a bottom perspective view of the inflatable spa of FIG. 10A;

FIG. 12 is a perspective end view of the outlet pipe component of the exemplary integrated structure of FIG. 10A; and

FIG. 13 is a perspective end view of an exemplary controller and inlet pipe component of the exemplary integrated structure of FIG. 10A.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure.

### DETAILED DESCRIPTION OF THE EMBODIMENTS

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

In the description of the present disclosure, it should be noted that the terms “up”, “down”, “inside”, “outside”, “top/bottom”, etc. indicate the orientation or position relationship based on the orientation or position relationship shown in the attached drawings, only for the convenience of describing the present disclosure and simplifying the description, rather than indicating or implying that the device or component referred to must have a specific orientation, or be constructed and operated in a specific orientation. Therefore, it cannot be understood as a limitation on the present disclosure. In addition, the terms “first” and “second” are only used to describe and cannot be understood as indicating or implying relative importance.

In the description of the present disclosure, it should be noted that unless otherwise specified and limited, the terms “installation”, “set with”, “set/connected”, “connected”, etc. should be understood broadly. For example, “connected” can be a wall mounted connection, a detachable connection, or an integrated connection, can be a mechanical connection, can be an electrical connection, can be directly connected, or can be indirectly connected through an intermediate medium, can be the internal connection between two components, and for ordinary technical personnel in this field, the specific meaning of the above terms in the present disclosure can be understood in a specific situation.

The terms “couples”, “coupled”, “coupler”, and variations thereof are used to include both arrangements wherein two or more components are in direct physical contact and arrangements wherein the two or more components are not in direct contact with each other (e.g., the components are “coupled” via at least a third component, but yet still cooperates or interact with each other).

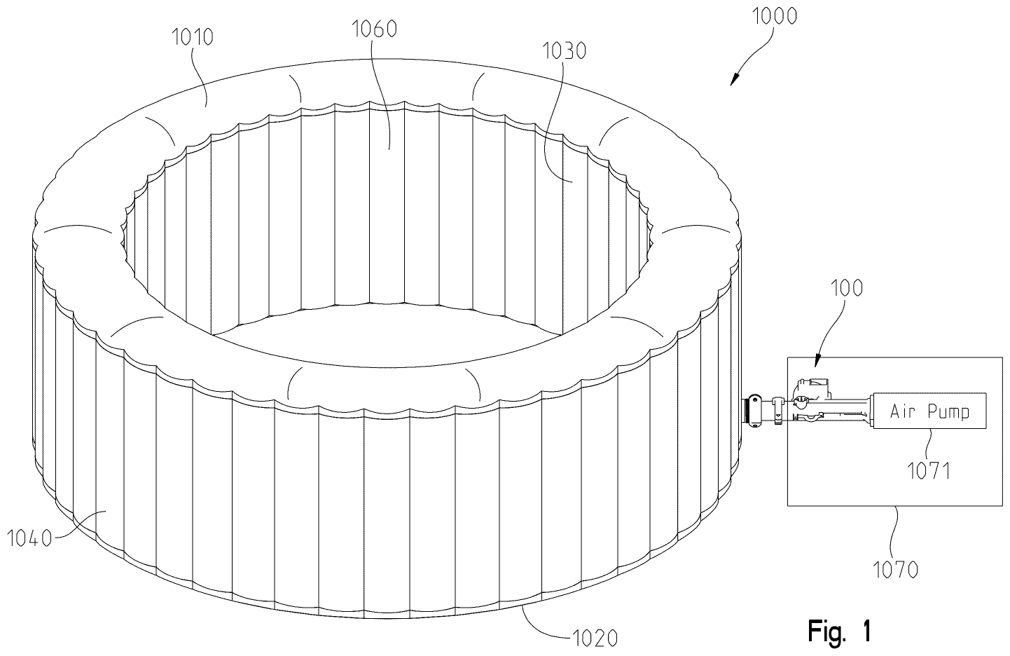

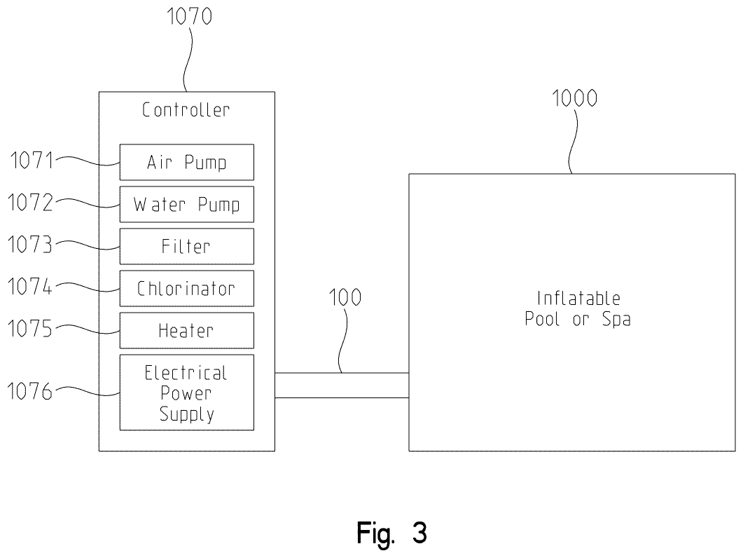

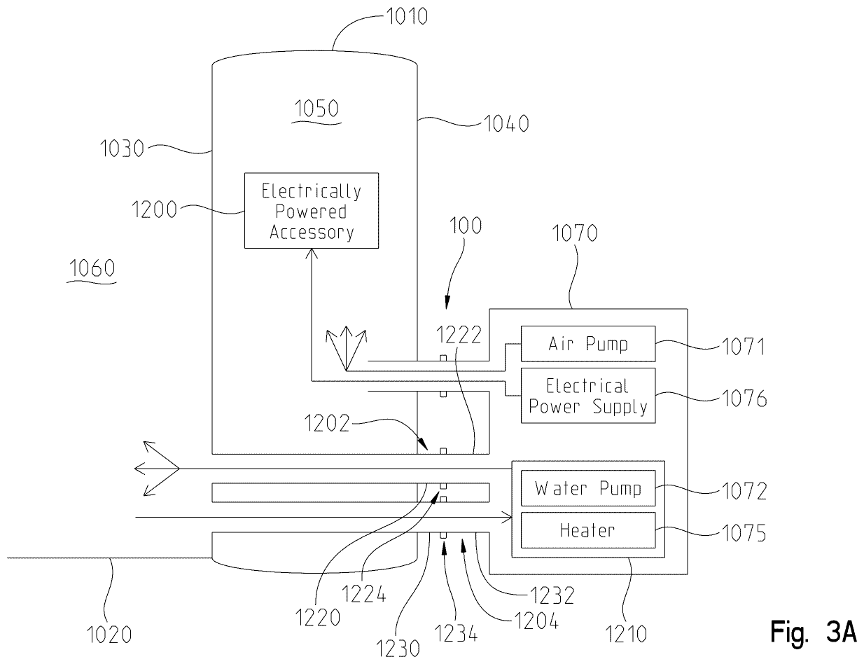

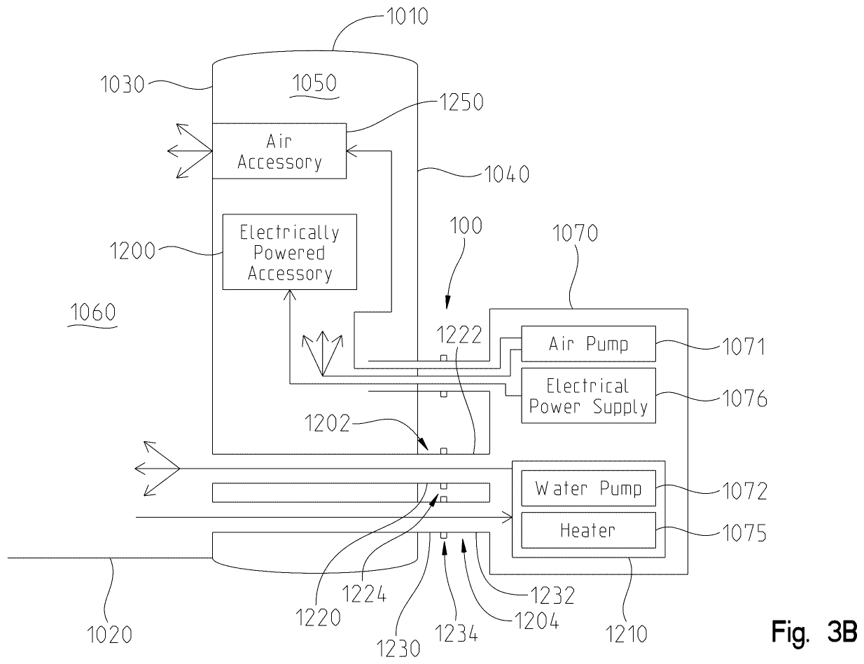

Referring to FIGS. 1-3, the present disclosure provides an integrated structure 100 for connecting a controller 1070 to an inflatable pool or spa 1000. As shown schematically in FIG. 3, controller 1070 may include one or more components, such as an air pump 1071, a water pump 1072, a filter 1073, a chlorinator 1074, a heater 1075, an electrical power supply 1076, and/or combinations thereof.

The illustrated inflatable pool or spa 1000 includes a top wall 1010, a bottom wall 1020, a first side wall 1030, and a second side wall 1040. The second side wall 1040 may be disposed around the first side wall 1030, and the bottom wall 1020 may be connected to a bottom of the second side wall 1040 and a bottom of the inner side wall 1030. The top wall 1010 may be connected to a top of the second side wall 1040 and a top of the first side wall 1030.

The top wall 1010, bottom wall 1020, first side wall 1030, and second side wall 1040 of the inflatable pool or spa 1000 may define an inflatable air cavity 1050, and the first side wall 1030 and the bottom wall 1020 may define a water cavity 1060 when the inflatable air cavity 1050 is inflated. One or more tensioning structures 1080 may be positioned within air cavity 1050 and may couple first sidewall 1030 to second side wall 1040.

As will be described further below, the integrated structure 100 may include an air passage configured to connect the air pump 1071 of controller 1070 to the inflatable air cavity 1050 of the inflatable pool or spa 1000 for inflation of the inflatable air cavity 1050 or deflation of the inflatable air cavity 1050. The integrated structure 100 may also include an air passage configured to connect air pump 1071 of controller 1070 to the water cavity 1060 to provide massaging bubbles to the water cavity 1060.

The integrated structure 100 may also comprise a pair of electrical connection terminals adapted to couple to one another to form a circuit to supply electricity from electrical power supply 1076 of the controller 1070 to one or more accessories accessible from within the inflatable air cavity 1050 of the inflatable pool or spa 1000. Exemplary accessories include audio accessories, such as speakers, visual accessories, such as a display screen or a lighting system, such as an LED strip including a plurality of LED lights, and tactile accessories, such as piezoelectric elements which provide massaging features.

Referring to FIG. 3A, a first arrangement of inflatable spa 1000, controller 1070, and integrated structure 100 is shown. Electrical power supply 1076 of controller 1070 is operatively coupled to an electrically powered accessory 1200 positioned within inflatable air cavity 1050 of inflatable spa 1000. Further, air pump 1071 of controller 1070 is fluidly coupled with the interior of inflatable air cavity 1050 of inflatable spa 1000. In embodiments, each of the connection of electrical power supply 1076 to electrically powered accessory 1200 and the connection of air pump 1071 to inflatable air cavity 1050 pass through the same conduit within integrated structure 100. In embodiments, each of the connection of electrical power supply 1076 to electrically powered accessory 1200 and the connection of air pump 1071 to inflatable air cavity 1050 pass through respective separate conduits within integrated structure 100. Electrically powered accessory 1200 may be untethered within inflatable air cavity 1050 or coupled to one of first side wall 1030, second side wall 1040, top wall 1010, or tensioning structures 1080, either directly or indirectly, such as positioned within a sleeve coupled to one or more of first side wall 1030, second side wall 1040, top wall 1010, and tensioning structures 1080.

As shown in FIG. 3A, controller 1070 is further connected to inflatable spa 1000 through a first water conduit 1202 and a second water conduit 1204. Each of first water conduit 1202 and second water conduit 1204 connect a water unit 1210 of controller 1070, illustratively comprising water pump 1072 and heater 1075, to water cavity 1060 of inflatable spa 1000 to recirculate water between water cavity 1060 and controller 1070. Each of first water conduit 1202 and second water conduit 1204 may be formed by a first conduit 1220, 1230 coupled to inflatable spa 1000 and a second conduit 1222, 1232 coupled to controller 1070, the first and second conduits being releasably secured to each other through respective joints 1224, 1234. An advantage, among others, of having the connection between electrically powered accessory 1200 and electrical power supply 1076 being associated with integrated structure 100 instead of either of connections 1202 or 1204 is maintaining the electrical connection spaced apart from water connections. An advantage, among others, of having the connection between electrically powered accessory 1200 and electrical power supply 1076 pass internal to integrated structure 100 is to keep the electrical connection from being exposed to the elements of the surrounding environment. In embodiments, the connection between electrically powered accessory 1200 and electrical power supply 1076 is external to integrated structure 100.

Referring to FIG. 3B, a second arrangement of inflatable spa 1000, controller 1070, and integrated structure 100 is shown. Electrical power supply 1076 of controller 1070 is operatively coupled to electrically powered accessory 1200 positioned within inflatable cavity 1050 of inflatable spa 1000. Further, air pump 1071 of controller 1070 is fluidly coupled with the interior of inflatable air cavity 1050 of inflatable spa 1000 and fluidly coupled to an air accessory 1250. Air accessory 1250 may be an air jet that provides bubbles to water cavity 1060 of inflatable spa 1000. In embodiments, air accessory 1250 may be a combined air and water accessory, such as a jet that provides both pressurized water and air bubbles. In embodiments, the connection of air pump 1071 to inflatable air cavity 1050 and the connection of air pump 1071 to air accessory 1250 pass through different conduits within integrated structure 100. In embodiments, each of the connection of electrical power supply 1076 to electrically powered accessory 1200 and one of the connection of air pump 1071 to inflatable air cavity 1050 or air pump 1071 to air accessory 1250 pass through the same conduit within integrated structure 100. In embodiments, each of the connection of electrical power supply 1076 to electrically powered accessory 1200, the connection of air pump 1071 to inflatable air cavity 1050, and the connection of air pump 1071 to air accessory 1250 pass through respective separate conduits within integrated structure 100. Electrically powered accessory 1200 may be untethered within inflatable air cavity 1050 or coupled to one of first side wall 1030, second side wall 1040, top wall 1010, or tensioning structures 1080, either directly or indirectly, such as positioned within a sleeve coupled to one or more of first side wall 1030, second side wall 1040, top wall 1010, and tensioning structures 1080.

As shown in FIG. 3B, controller 1070 is further connected to inflatable spa 1000 through a first water conduit 1202 and a second water conduit 1204.

Each of first water conduit 1202 and second water conduit 1204 connect a water unit 1210 of controller 1070, illustratively comprising water pump 1072 and heater 1075, to water cavity 1060 of inflatable spa 1000 to recirculate water between water cavity 1060 and controller 1070. Each of first water conduit 1202 and second water conduit 1204 may be formed by a first conduit 1220, 1230 coupled to inflatable spa 1000 and a second conduit 1222, 1232 coupled to controller 1070, the first and second conduits being releasably secured to each other through respective joints 1224, 1234. An advantage, among others, of having the connection between electrically powered accessory 1200 and electrical power supply 1076 being associated with integrated structure 100 instead of either of connections 1202 or 1204 is maintaining the electrical connection spaced apart from water connections. An advantage, among others, of having the connection between electrically powered accessory 1200 and electrical power supply 1076 pass internal to integrated structure 100 is to keep the electrical connection from being exposed to the elements of the surrounding environment. In embodiments, the connection between electrically powered accessory 1200 and electrical power supply 1076 is external to integrated structure 100.

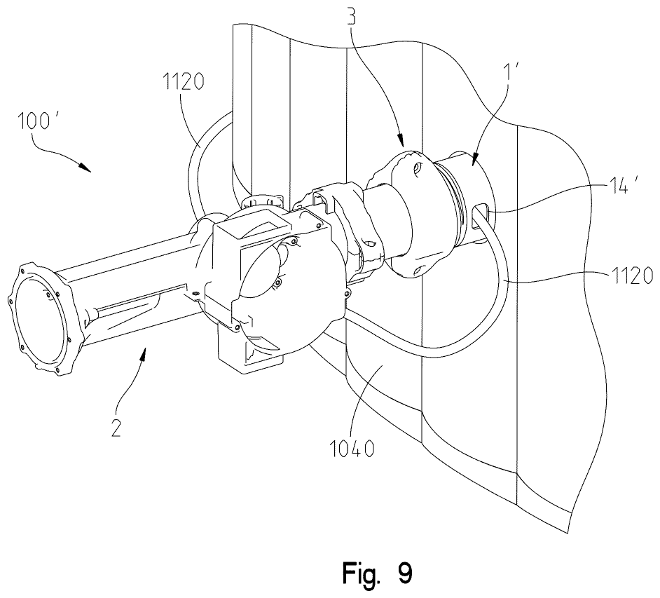

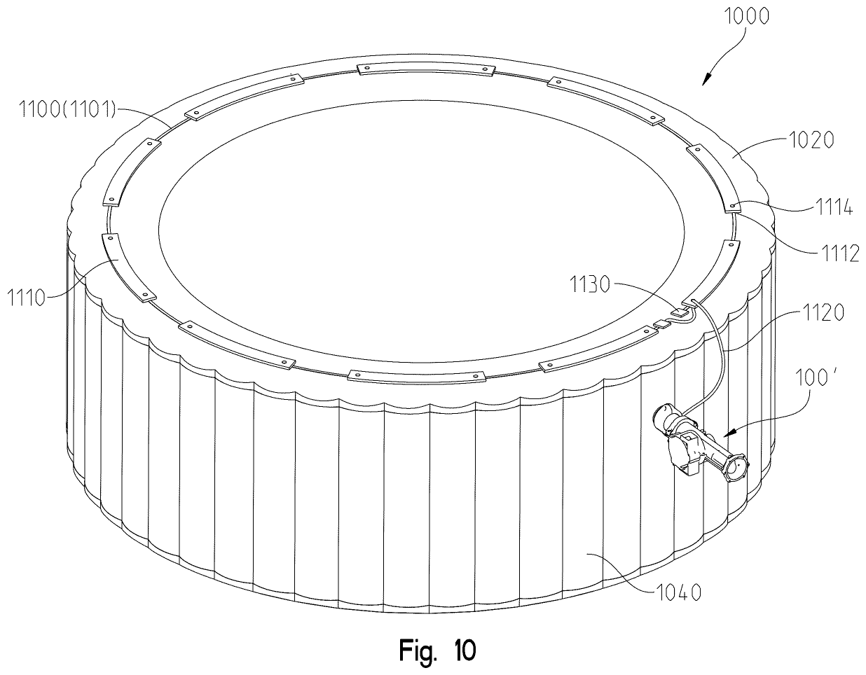

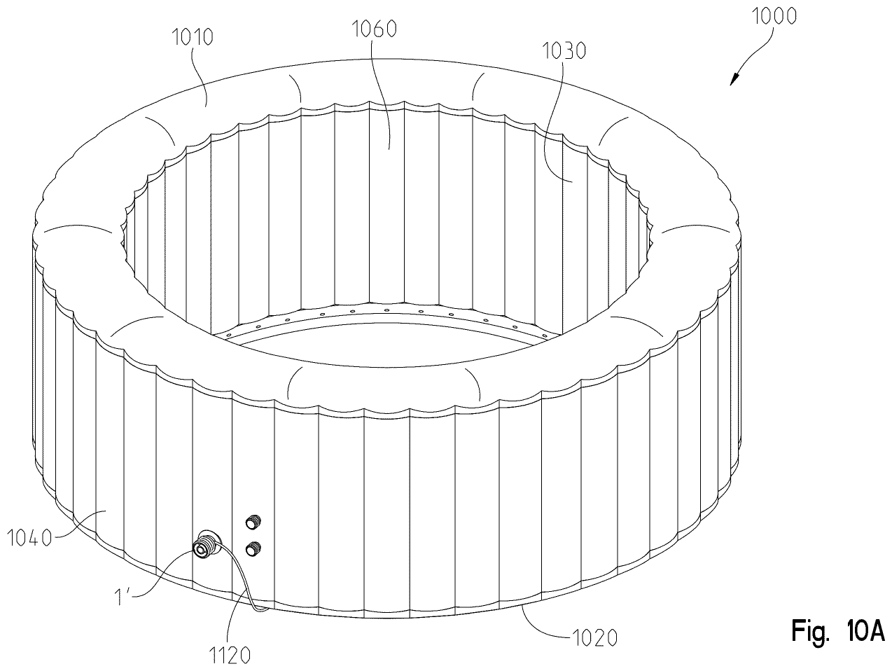

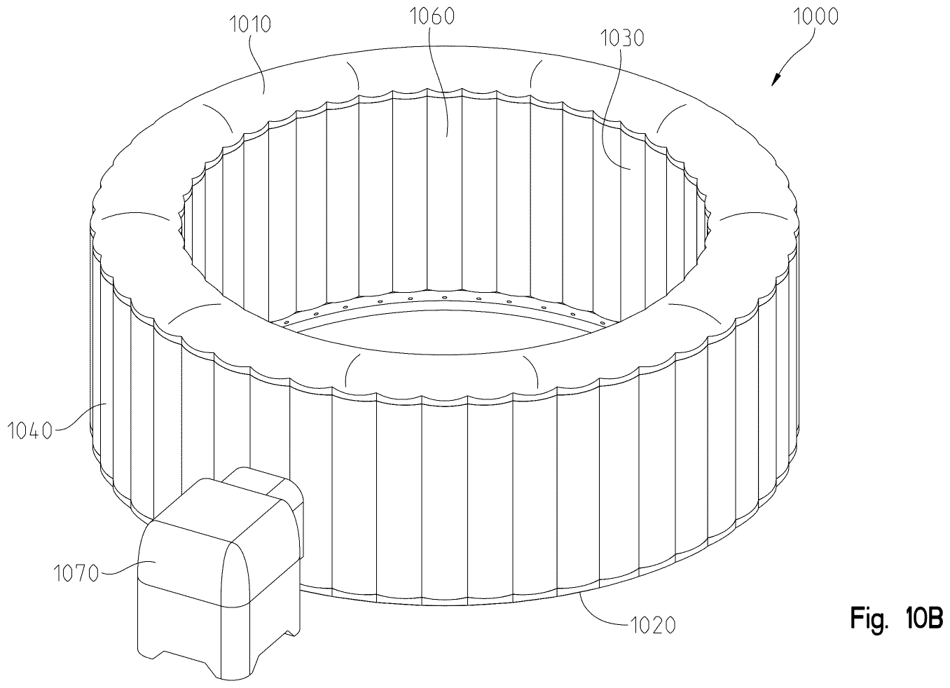

As will be described below, embodiments, such as integrated structure 100′shown in FIGS. 9 and 10, may be configured to supply electricity from electrical power supply 1076 of the controller 1070 to one or more accessories accessible from outside of the air cavity of the inflatable pool or spa, such as LED lighting coupled to a bottom surface of bottom wall 1040 as shown in FIG. 10. Further exemplary accessories include audio accessories, such as speakers, visual accessories, such as a display screen or a lighting system, such as an LED strip including a plurality of LED lights, and tactile accessories, such as piezoelectric elements which provide massaging features.

In embodiments, the electrical power supply 1076 of controller 1070 provides a low voltage DC power, such as 12 volts, 24 volts, 5 volts, or in a range of 5 volts to 24 volts, to the electrically powered accessories. In embodiments, in addition to dedicated power lines, the integrated device may also include dedicated data lines to provide data signals between controller 1070 and the one or more electrically powered accessories 1200. In embodiments, in addition to or in place of visual accessories, audio accessories, and/or tactile accessories, other electrically powered accessories may be coupled to the electrical power supply of controller 1070. Exemplary other electrically powered accessories include electrically actuatable valves which may be coupled to massage water passageways which provide massaging water jets through the inner wall of the inflatable chamber that bounds the water cavity and/or water fountains. Additional exemplary other electrically powered accessories include one or more sensors which may provide a characteristic to the water cavity to controller 1070 such as occupancy sensors which monitor one or more characteristics to determine when a user has entered the water cavity.

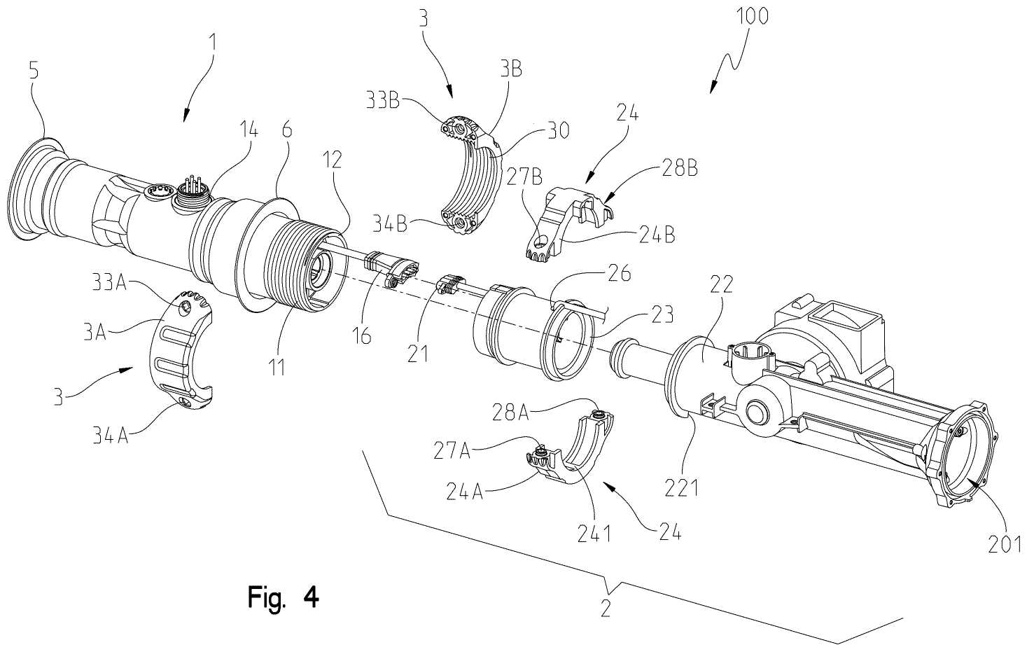

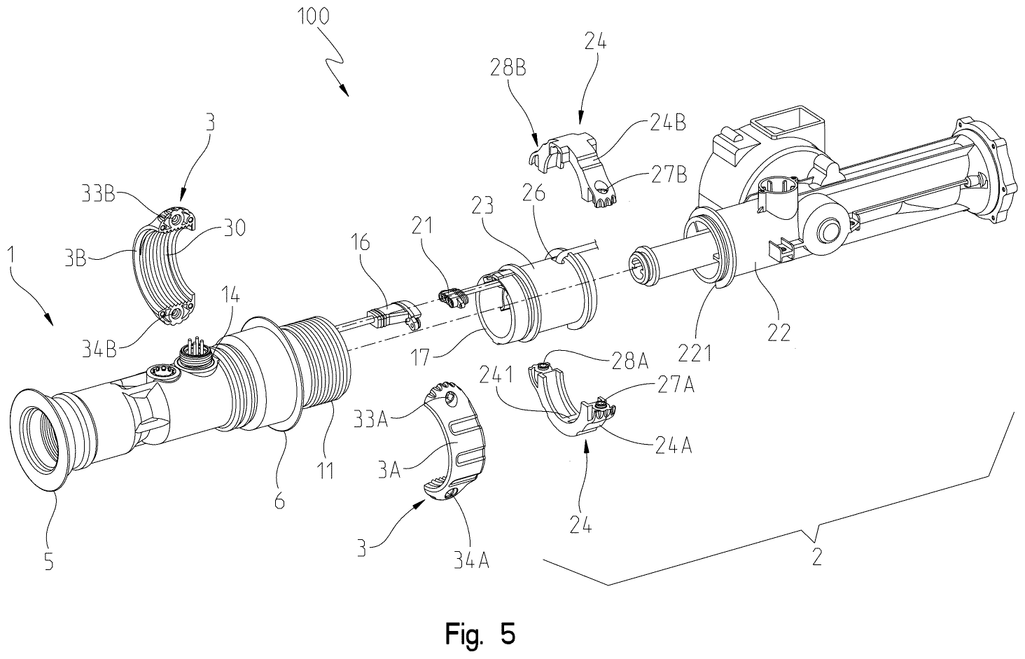

Referring to FIGS. 4 and 5, the integrated structure 100 may comprise an air outlet pipe component 1, an air inlet pipe component 2, and a joint 3 configured to connect the air outlet pipe component 1 to the air inlet pipe component 2.

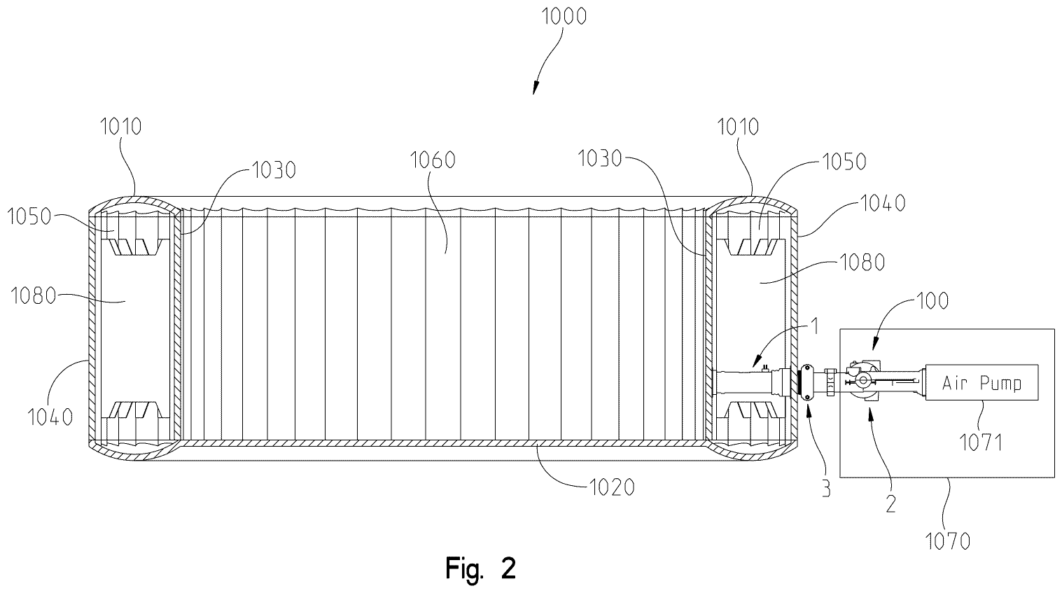

Outlet pipe component 1 may include a first flanged end 5 fused or otherwise coupled to an inner side of first side wall 1030 and a second flanged end 6 fused or otherwise coupled to an inner side of the second side wall 1040. Thus, as shown in FIG. 2, outlet pipe component 1 is positioned substantially within air cavity 1050, although at least a portion of outlet pipe component 1 protrudes out of air cavity 1050. Although not shown, in embodiments, outlet pipe component 1 may include a valve to prevent backflow of water from water cavity 1060 into outlet pipe component 1. Further, in embodiments, outlet pipe component 1 is not directly coupled to side wall 1030 as shown, but rather is coupled to a pipe network internal to inflatable air cavity 1050 which includes ports, such as jets or other openings, which communicate air to water cavity 1060 at various locations about inflatable spa 1000.

As shown in FIGS. 1 and 2, inlet pipe component 2 may be positioned substantially within controller 1070, although a portion of inlet pipe component 2 protrudes from controller 1070 to connect to outlet pipe component 1 via joint 3. At the open end 201 of inlet pipe component 2 facing away from outlet pipe component 1, inlet pipe component 2 may be connected to an outlet of air pump 1071 to receive airflow therefrom.

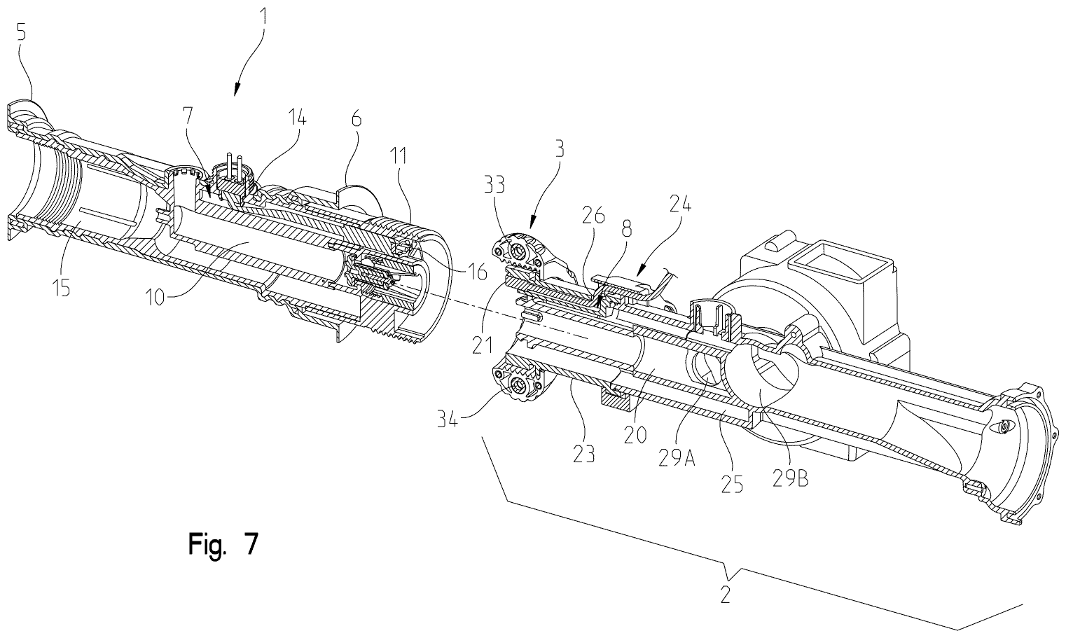

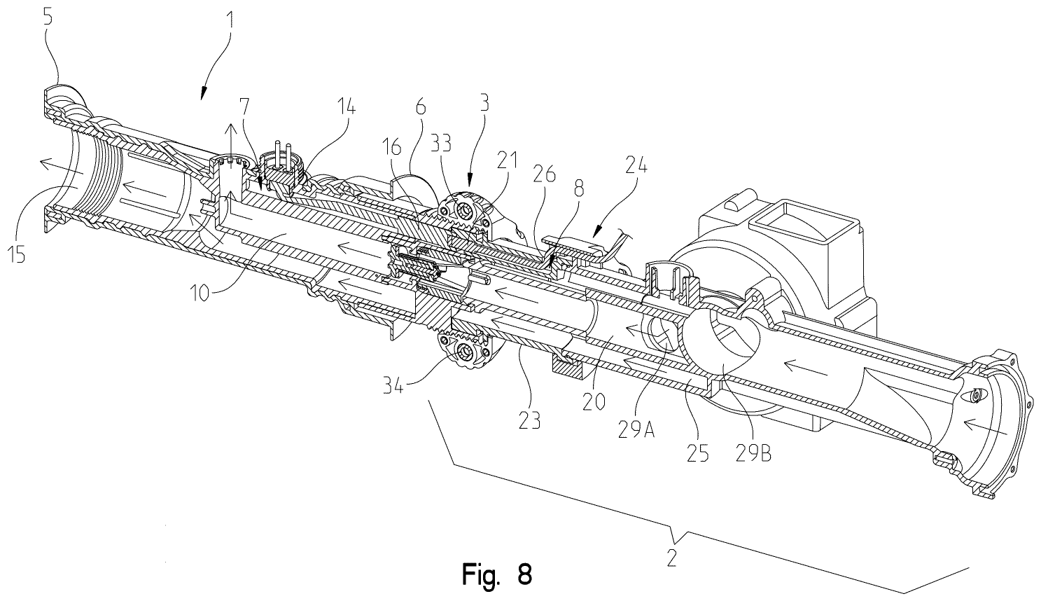

As shown in FIGS. 7 and 8, outlet pipe component 1 may include one or more air passages extending therethrough, and inlet pipe component 2 may also include one or more air passage extending therethrough and configured to be fluidly coupled to the one or more air passages of the outlet pipe component 1. Thus, as introduced above, the one or more air passages of the outlet pipe component 1 and the one or more air passages of the inlet pipe component 2 may form one or more air passages configured to fluidly connect the controller 1070 of the inflatable pool or spa 1000 to the air cavity 1050 or water cavity 1060 of the inflatable pool or spa 1000.

Referring still to FIGS. 7 and 8, outlet pipe component 1 may include a first outlet air passageway 10 and a second outlet air passageway 15. The first and second outlet air passageways may be fluidly isolated from one another. First outlet air passageway 10 may be in fluid communication with air cavity 1050 for inflation or deflation operations, and second outlet air passageway 15 may be in fluid communication with water cavity 1060 to supply massaging bubbles to water cavity 1060.

As shown in FIGS. 7 and 8, inlet pipe component 2 may include a first inlet air passageway 20 and a second inlet air passageway 25. First inlet air passageway 20 may be configured to connect to first outlet air passageway 10 of the outlet pipe component 1. Thus, during inflation of air cavity 1050, air may flow from air pump 1071 of controller 1070 through first inlet air passageway 20 and first outlet air passageway 10, and into air cavity 1050. Second inlet air passageway 25 may be configured to connect to second outlet air passageway 15 of outlet pipe component 1. Accordingly, during massaging bubble operations, air may flow from air pump 1071 of controller 1070 through second inlet air passageway 25, through second outlet air passageway 15, and into water cavity 1060. A rotatable valve (not shown) may be positioned within inlet pipe component 2 and configured to place the integrated structure 100 in either an inflation or deflation position, or a massaging bubble position. Exemplary inflation and air bubble flow paths are depicted in FIG. 8. It should be understood that inflation, deflation, and massaging bubble operations are in the alternative, rather than simultaneous.

Returning to FIGS. 4 and 5, respective end faces 12, 17 of the outlet pipe component 1 and the inlet pipe component 2 may face each other, and each end face 12, 17 may be equipped with an electrical connection terminal. Thus, when the joint 3 connects the outlet pipe component 1 to the inlet pipe component 2, the air passages of the outlet pipe component 1 and the inlet pipe component 2 are interconnected, and the electrical connection terminals form an electrical connection configured to supply electricity to a feature of the inflatable pool or spa, such as LED lighting.

As shown in FIGS. 4 and 5, a rotating component 23 of the inlet pipe component 2 may include a conductor inlet 26 for receiving an electrical conductor, such as wire or a plug, and the outlet pipe component 1 may include a conductor outlet 14 allowing a conductor, such as a wire or plug, to exit the outlet pipe component 1 into air cavity 1050. Thus, electrical components extending from electrical power supply 1076 of controller 1070 of the inflatable pool or spa 1000 may be concealed within the integrated structure 100 and may exit the outlet pipe component 1 into air cavity 1050 to supply electricity to one or more accessories accessible 1200 within air cavity 1050. Once inside the air cavity 1050, depending on the placement of the one or more accessories 1200, the electrical wires (not shown) may run above, below, or through openings within tensioning structures 1080, for example.

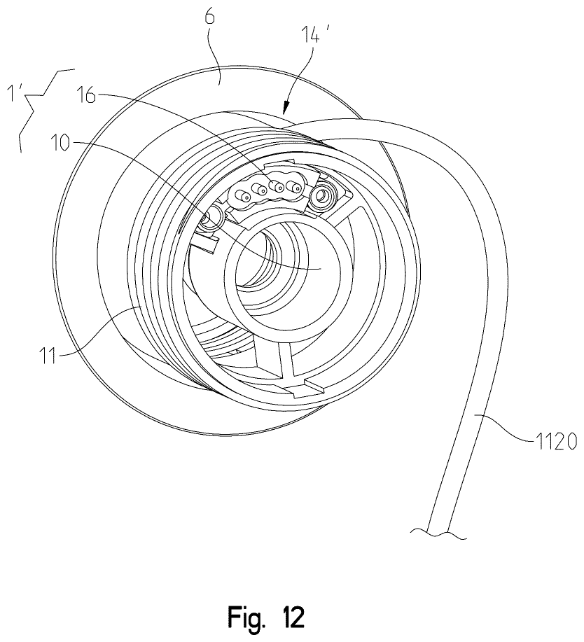

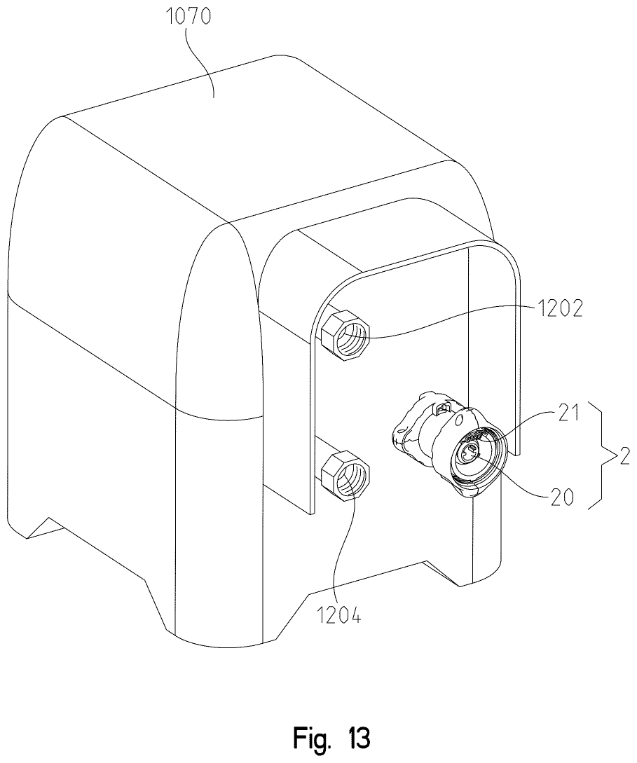

In the embodiment depicted in FIGS. 9-13, outlet pipe component 1′of integrated structure 100′includes a conductor outlet 14′positioned relative to second flanged end 6 such that conductor outlet 14′is positioned outside of air cavity 1050, rather than within air cavity 1050. In the illustrated embodiment, conductor outlet 14′is depicted as an opening through which a conductor may extend. In other embodiments, conductor outlet 14′is threaded and configured to receive a conductor, such as a plug. Accordingly, an accessory, such as a luminous device 1100, which may include a luminous strip 1101, illustratively an LED lighting feature, positioned on or near an external surface of the inflatable pool or spa may connect to the conductor outlet 14′to receive electricity therefrom.

For example, as shown in FIGS. 9 and 10, inflatable pool or spa 1000 includes a luminous device 1100, illustratively an LED strip 1101, disposed around a perimeter of bottom wall 1020. LED lighting strip 1101 is coupled to the bottom wall 1020 via fixing piece 1110. In embodiments, LED lighting strip 1100 may be coupled to the bottom wall 1020 via adhesive or other suitable methods of connection. An electrical connector 1120 may connect the LED lighting strip 1101 to the conductor outlet 14′to receive electricity therefrom. The LED lighting strip 1101 may terminate at end seal 1130.

When the luminous device 1100 emits light while operating, the light emitted by the luminous strip 1101 will pass through the bottom wall 1020 and enter the water cavity 1060 of the inflatable pool 1000, thereby illuminating the water flow contained within the water cavity 1060. This provides effective illumination for occupants inside the inflatable pool 1000, which may enhance enjoyment of the inflatable pool 1000 during nighttime use. The luminous strip 1101 may be fitted on the bottom side of the bottom wall 1020 of the inflatable pool 1000. Consequently, when using the inflatable pool 1000, the luminous strip 1101 may be sandwiched between the inflatable pool 1000 and the ground or other support, such as a concrete pad, and the inflatable pool 1000 covers the luminous strip 1101, thereby concealing the luminous strip 1101. This design may improve the overall aesthetics of the inflatable pool 1000 during use and may reduce the risk of occupants contacting the luminous strip 1101.

In the embodiments, the luminous strip 1101 may be a flexible LED strip, allowing the luminous strip 1101 to be bent and facilitating the positioning of the luminous strip 1101.

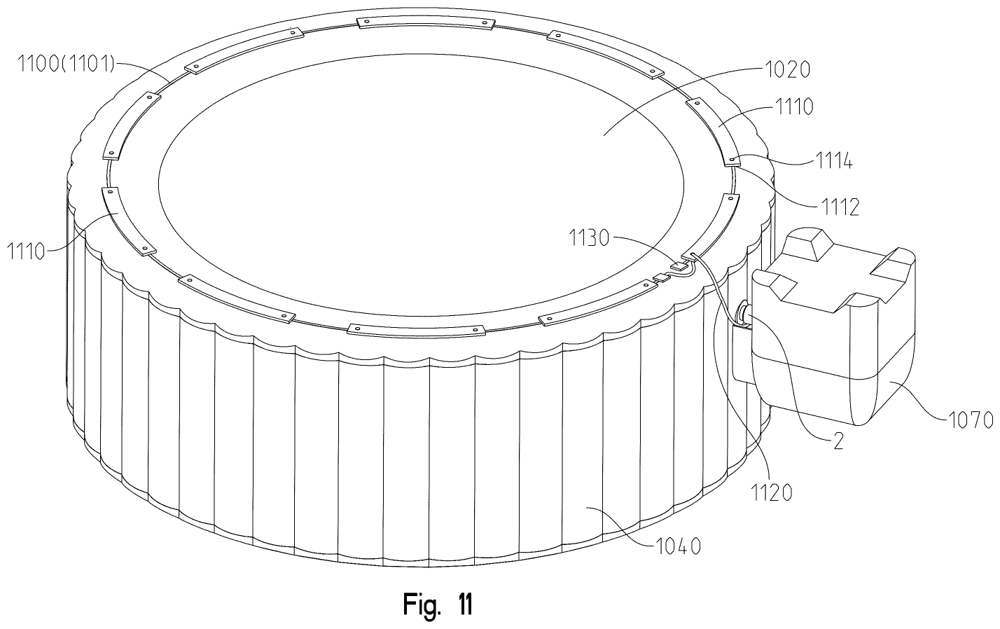

As shown in FIGS. 10 and 11, the luminous strip 1101 may be disposed in a ring shape on the bottom side of the bottom wall 1020 of the inflatable pool 1000 and substantially span the perimeter of the bottom wall 1020. Bottom wall 1020 may include a light-transmitting material. The luminous strip 1101 is positioned opposite the top wall 1010 of the inflatable pool 1000, and the first side wall 1030 of the inflatable pool 1000 may include a light-transmitting material.

When the luminous strip 1101 emits light while operating, the light emitted by the luminous strip 1101 will pass through the bottom wall 1020 and the first side wall 1030 and enter the water cavity 1060 of the inflatable pool 1000, thereby illuminating the water within the inflatable pool 1000. By positioning the luminous strip 1101 opposite the top wall 1010 of the inflatable pool 1000, the risk of occupants damaging the luminous strip 1101 may be reduced. Moreover, the force exerted by the water flow contained within the water cavity 1060 of inflatable pool 1000 on the luminous strip 1101 is minimal, thereby improving the safety of the luminous strip 1101. It should be noted that the luminous strip 1101 may also be disposed in the central area of the bottom wall 1020. In this case, the light emitted by the luminous strip 1101 directly enters the water cavity 1060 of the inflatable pool 1000 through the bottom wall 1020. In this embodiment, as long as the inflatable pool 1000 is sufficiently deep and contains a sufficient amount of water, occupants may not damage the luminous strip 1101 due to the buoyancy of the water.

The top wall 1010 of the inflatable pool 1000 may include a light-transmitting material. This arrangement allows the light emitted by the luminous strip 1101, positioned opposite the top wall 1010 of the inflatable pool 1000, to pass through the bottom wall 1020 and the top wall 1010, thereby illuminating the top part of the inflatable pool 1000. This may provide better lighting effects and enhance the enjoyment for occupants.

The second side wall 1040 of the inflatable pool 1000 may also include a light-transmitting material. The light emitted by the luminous strip 1101 may pass through the bottom piece 1020 and the second side wall 1040, illuminating the outer side of the inflatable pool 1000. This configuration may also enhance the lighting effects and user enjoyment.

As discussed above, top wall 1010, bottom wall 1020, first side wall 1030, and/or second side wall 1040 may include a light-transmitting material, such as a transparent or semi-transparent flexible material or film. In embodiments, top wall 1010, bottom wall 1020, first side wall 1030, and/or second side wall 1040 may include a combination of transparent, semi-transparent, and/or opaque flexible material or film.

The bottom wall 1020 of the inflatable pool 1000 may be connected to at least one fixing piece 1110. A fitting channel 1112 for housing the luminous strip 1101 may be formed between the fixing piece 1110 and the bottom wall 1020, and the luminous strip 1101 may be received within the fitting channel 1112.

Accordingly, the bottom wall 1020 and the fixing piece 1110 may cooperate to couple the luminous strip 1101 to the bottom side of the bottom wall 1020. The fixing piece 1110 may be welded or otherwise coupled, such as by adhesive, to the bottom wall 1020 and may be provided with an opening 1114. During installation of the luminous strip 1101, an installer's fingers can pass through the opening 1114 to apply force to the luminous strip 1101, simplifying installation of the luminous strip 1101 for the installer.

As discussed above, the inflatable pool 1000 may include a controller 1070. The controller 1070 may electrically connect to the luminous strip 1101 via electrical power supply 1076 and integrated structure 100′and may control the operation of the luminous strip 1101. The controller 1070 may control whether the luminous strip 1101 operates, the luminous color of the luminous strip 1101, and the color temperature of the luminous strip 1101.

As introduced earlier, the controller 1070 may include air pump 1071, water pump 1072, filter 1073, chlorinator 1074, heater 1075, and electrical power supply 1076, alone or in combination. Integrated structure 100′may connect the controller 1070 to the inflatable pool 1000. Integrated structure 100′may include outlet pipe component l′ and inlet pipe component 2. Inlet pipe component may be provided with an electrical connection terminal 21 connected to the electrical power supply 1076 and one or more air passageways connected to the air pump 1071.

The inflatable pool 1000 may be provided with an outlet pipe component 1′for connecting to the inlet pipe component 2. The outlet pipe component 1′may be provided with an electrical connection terminal 16, which may be electrically connected to the luminous strip 1101, and one or more air passageways connected to the air cavity 1050 or water cavity 1060 of inflatable pool 1000. Electrical connection terminal 16 may couple to electrical connection terminal 21 via compatible cooperating features, such as pins and recesses, mutual threads, or magnetism, and the one or more air passageways of the outlet pipe component 1′ may fluidly couple to the one or more air passageways of the inlet pipe component 2.

An advantage, among others, of this arrangement is that as long as the outlet pipe component 1′is connected to the inlet pipe component 2, the electrical connection terminal 16 can be coupled to the electrical connection terminal 21 of the inlet pipe component 2, and the one or more air passageways of the outlet pipe component 1′may fluidly connect to the one or more air passageways of the inlet pipe component 2, making it convenient to connect the controller 1070 to the inflatable pool 1000 and the luminous strip 1101. The controller 1070 may control the inflation and deflation of the inflatable pool 1000 by controlling the air pump 1071, while the electrical power supply 1076 of the controller 1070 may control the operation of the luminous strip 1101. The outlet pipe component 1′may be fused or otherwise coupled to the second side wall 1040 of the inflatable pool 1000, making it easier to connect the outer pipe component 1′to the inlet pipe component 2, with the controller 1070 positioned on the exterior side of the inflatable pool 1000.

The electrical connection terminal 16 is electrically connected to the luminous strip 1101 through a conductor, such as cord 1120. Cord 1120 may pass through the opening 1114 on the fixing piece 1110.

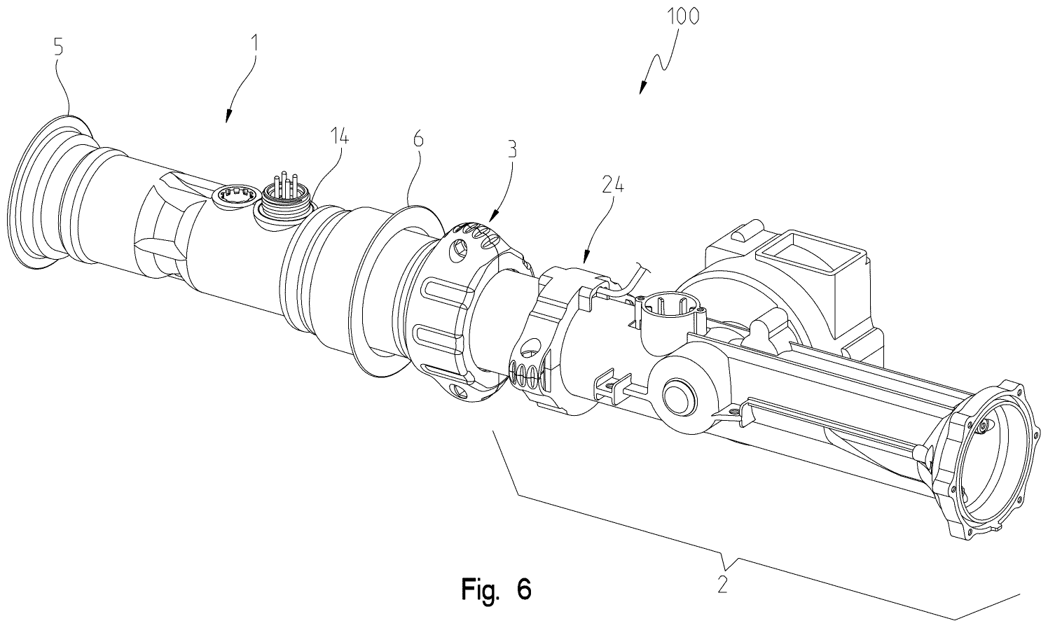

Now returning to FIGS. 4-6, joint 3 may be threaded with threads 30. To connect the outlet pipe component 1 to the inlet pipe component 2, joint 3 is positioned at an end of the inlet pipe component 2 facing the outlet pipe component 1, and the outer wall of the outlet pipe component 1 may be threaded with threads 11 that are configured to threadably engage with the threads 30 of joint 3. As shown in, for example, FIGS. 4-6, the joint 3 includes a pair of semicircular joint members 3A, 3B, and the semicircular joint members 3A, 3B include coaxial apertures 33A and 33B, and 34A and 34B configured to receive screws or other suitable fasteners for coupling the joint members 3A, 3B together when the joint 3 couples the outlet pipe component 1 to the inlet pipe component 2.

To achieve the abovementioned electrical connection between outlet pipe component 1 and inlet pipe component 2, the outlet pipe component 1 and inlet pipe component 2 may each include electrical connection terminals having compatible cooperating features, such as pins and recesses. For example, in the illustrated embodiment, an end of the inlet pipe component 2 facing the outlet pipe component 1 has an electrical connection terminal, illustratively power female connector 21, and the end of the outlet pipe component 1 facing the inlet pipe component 2 has an electrical connection terminal, illustratively power male connector 16. In embodiments, the electrical connection terminals of the outlet pipe component 1 and inlet pipe component 2 may be switched such that the inlet pipe component 2 has a power male connector and the outlet pipe component 1 has a power female connector. A plug-in fit relationship is thus formed between female connector 21 and male connector 16, which can form a stable electrical connection. The plug-in coordination can also be changed to a common electrical connection structure in existing technologies such as magnetic, suction, or other suitable methods of connecting the electrical connection terminals.

The electrical connection terminal 16 of the outlet pipe component 1 may be disposed substantially within outlet pipe 1. For example, electrical connection terminal 16 may be positioned within an air passageway of outlet pipe component 1. Similarly, electrical connection terminal 21 of inlet pipe component 2 may be disposed substantially within inlet pipe component 2. For example, electrical connection terminal 21 may be positioned within an air passageway of inlet pipe component 2. Alternatively, as shown in FIGS. 7 and 8, the electrical connection terminal 16 of the outlet pipe component 1 and the electrical wire connected to the electrical connection terminal 16 may be contained substantially within an outlet electrical passageway 7. The electrical connection terminal 21 and electrical wire connected thereto may similarly be contained substantially within an inlet electrical passageway 8. Inlet electrical passageway 8 may be substantially formed by rotating component 23. Outlet electrical passageway 7 may be fluidly isolated from first and second outlet air passageways 10, 15.

Similarly, inlet electrical passageway 8 may be fluidly isolated from first and second inlet air passageways 20, 25.

Due to the electrical connection between inlet pipe component 2 and outlet pipe component 1, there are positional requirements for their connection to one another. Otherwise, female connector 21 and male connector 16 may not be electrically connected. For example, the air outlet component 1 is fused to the inflatable product, such as to the second side wall 1040 of the inflatable pool or spa 1000 and cannot be moved. If there is a deviation in the position of outlet pipe component 1, the electrical connection between outlet pipe component 1 and inlet pipe component 2 may not be made. Therefore, in embodiments, the inlet pipe component 2 may comprises an inlet pipe 22, a rotating component 23, and a connecting ring 24. The rotating component 23 may be rotationally connected to one end of the inlet pipe 22 towards the outlet pipe component 1 through the connecting ring 24. In this way, the rotating component 23 can rotate relative to inlet pipe 22 so that when there is a deviation in their positions, the rotating component 23 can realign the female electrical connection terminal 21 and the male electrical connection terminal 16.

The rotation of the rotating component 23 may be limited within a certain range, and the outer wall of the air inlet pipe 22 may be provided with a limit groove 221 extending partially along the circumference of the air outlet pipe 22. The connecting ring 24 may include a clamp block 241 that fits within the limit groove 221. Thus, the limit groove 221 may be used to limit the rotation range of the clamp block 241 and ultimately of rotating component 23. Although one limit groove 221 is depicted in the illustrated embodiment, the integrated structure 100 may include more than one limit groove, for example two or three limit grooves.

Referring to FIGS. 4 and 5, the connecting ring 24 may be divided into a first connecting ring, illustratively a first semicircular connecting ring 24A, and a second connecting ring, illustratively a second semicircular connecting ring 24B, configured to couple to the first connecting ring 24A. The first connecting ring 24A and the second connecting ring 24B may include coaxial apertures 27A and 27B, and 28A and 28B configured to receive screws or other suitable fasteners to couple the first connecting ring to the second connecting ring. The first connecting ring 24A and the second connecting ring 24B may be connected to form a clamping space for gripping the inlet pipe 22.

The integrated structure for connecting an air passage and a circuit can be applied to an air pump, which can be used on inflatable swimming pools or SPA swimming pools.

### EXAMPLES

Example 1: An inflatable pool may comprise an inflatable pool body, a controller releasably coupled to the inflatable body, and a luminous device. The inflatable pool body may include an inner side wall, an outer side wall disposed around the inner side wall, a top wall connected to a top of the inner side wall and a top the outer side wall, and a bottom wall connected to a bottom of the inner side wall and a bottom of the outer side wall. The luminous device may include a luminous strip coupled to a bottom side of the bottom wall, and the luminous device may be coupled to the controller to receive electrical power from the controller. The bottom wall may include a light-transmitting material.

Example 2: The inflatable pool according to Example 1, wherein the luminous strip may be disposed in a ring shape on the bottom side of the bottom wall of the inflatable pool body, and the luminous strip may be opposite the top wall of the inflatable pool body, and the inner side wall of the inflatable pool body may include a light-transmitting material.

Example 3: The inflatable pool according to Example 2, wherein the top wall of the inflatable pool body may include a light-transmitting material.

Example 4: The inflatable pool according to Example 2, wherein the outer side wall of the inflatable pool body may include a light-transmitting material.

Example 5: The inflatable pool according to any one of Examples 1 to 4, wherein the bottom wall of the inflatable pool body may be coupled to at least one fixing piece, and a fitting channel for housing the luminous strip may be formed between the fixing piece and the bottom wall.

Example 6: The inflatable pool according to any one of Examples 1-5, wherein the controller may include an air pump to provide air to the inflatable body and a water pump to provide water to the inflatable body.

Example 7: The inflatable pool according to Example 6, wherein the controller may include an electrical power supply, an air pump, and an inlet pipe component, the inlet pipe component may include a first electrical connection terminal connected to the electrical power supply and an inlet air passageway connected to the air pump. The inflatable pool body may include an outlet pipe component for connecting to the inlet pipe component, the outlet pipe component may include a second electrical connection terminal electrically connected to the luminous strip and an outlet air passageway in fluid communication with an inflatable air chamber of the inflatable pool body, the second electrical connection terminal may be configured to couple to the first electrical connection terminal of the inlet pipe component, and the outlet air passageway may be configured to fluidly couple to the inlet air passageway.

Example 8: The inflatable pool according to Example 7, wherein the outlet pipe component may be coupled to the outer side wall of the inflatable pool body.

Example 9: The inflatable pool according to Example 7, wherein the second electrical connection terminal of the outlet pipe component may be electrically connected to the luminous strip via a connecting wire.

Example 10: The inflatable pool according to Example 1, wherein the luminous strip may be a flexible LED strip.

Example 11: An integrated structure for connecting an air passage and a circuit may comprise an outlet pipe component, an inlet pipe component, and a joint configured to connect the outlet pipe component to the inlet pipe component. The outlet pipe component may comprise a first face and a first air passage extending along an axis that intersects the first face, and a first electrical connection terminal positioned proximate the first face. The inlet pipe component may comprise a second face facing the first face of the outlet pipe component, a second air passage configured to fluidly connect to the first air passage of the outlet pipe component, and a second electrical connection terminal positioned proximate the second face and configured to connect to the first electrical terminal. When the joint connects the outlet pipe component to the inlet pipe component, the first air passage of the outlet pipe component and the second air passage of the inlet pipe component may connect to form an air passage connection extending from the air inlet pipe component through the outlet pipe component, and the first electrical connection terminal of the outlet pipe component may couple to the second electrical connection terminal of the inlet pipe component to form an electrical connection therewith.

Example 12: The integrated structure according to Example 11, wherein the joint may comprise threads and may be sleeved at one end of the inlet pipe component facing the outlet pipe component, and an outer wall of the outlet pipe component may be externally threaded and configured to threadably engage with the threads of the joint.

Example 13: The integrated structure according to Example 12, wherein the second electrical connection terminal of the inlet pipe component may be a power female connector and the first electrical connection terminal of the outlet pipe component may be a power male connector.

Example 14: The integrated structure according to Example 13, wherein the inlet pipe component may comprise an inlet pipe, a rotating component, and a connecting ring, and the rotating component may be rotationally connected to the end of the inlet pipe facing the outlet pipe component through the connecting ring.

Example 15: The integrated structure according to Example 14, wherein an outer wall of the inlet pipe may be provided with a limit groove extending partially along the circumference of the outer wall, and the connecting ring may comprise a clamp block that fits within the limit groove, and the limit groove may limit the rotation range of the clamp block.

Example 16: The integrated structure according to Example 15, wherein the connecting ring may be divided into a semicircular first connecting ring, which may comprise a first clamp block, and a semicircular second connecting ring, which may comprise a second clamp block, the first connecting ring and the second connecting ring may be connected to form a clamping space for clamping the inlet pipe.

Example 17: The integrated structure according to Example 16, wherein the integrated structure may further comprise at least one limit groove, the limit groove may be rotatably matched with the first clamping block of the first connecting ring and the second clamping block of the second connecting ring.

Example 18: An air pump comprising an air pump body and the integrated structure according to any one of Examples 11-17.

Example 19: A swimming pool may comprise the air pump according to Example 18.

Example 20: The swimming pool according to Example 19, wherein the swimming pool may be a SPA swimming pool.

Example 21: An integrated connection device. configured to connect a controller to an inflatable pool having an air cavity and a water cavity. may comprise an inlet pipe coupled to the controller, an outlet pipe including a portion positioned between the inlet pipe and the inflatable pool, and a joint configured to couple the inlet pipe to the outlet pipe. The inlet pipe may comprise an inlet air passageway and an inlet electrical conductor positioned at least partially within the inlet pipe. The outlet pipe may comprise an outlet air passageway and an outlet electrical conductor positioned at least partially within the outlet pipe. The inlet air passageway may be coupled to the outlet air passageway when the joint couples the inlet pipe to the outlet pipe.

Example 22: The integrated connection device according to Example 21, wherein the inlet electrical conductor may be electrically coupled to the outlet electrical conductor when the joint couples the inlet pipe to the outlet pipe.

Example 23: The integrated connection device according to any one of Examples 21 and 22, wherein the inlet pipe may further comprise a rotating component rotatably coupled to an end of the inlet pipe facing the outlet pipe, and a connecting ring may be configured to couple the rotating component to the inlet pipe.

Example 24: The integrated connection device according to Example 23, wherein a first end of the inlet electrical conductor is accessible from an exterior of the rotating component.

Example 25: The integrated connection device according to any one of Examples 23 and 24, wherein the rotating component may comprise a portion of the inlet air passageway of the inlet pipe and a separate electrical passageway which receives the electrical conductor.

Example 26: The integrated connection device according to Example 23, wherein the inlet pipe may further comprise a groove, and the connecting ring may comprise a block configured to be positioned within the groove of the inlet pipe, the block of the connecting ring may limit the rotation of the rotating component relative to the inlet pipe.

Example 27: The integrated connection device according to Example 21, wherein the inlet pipe may further comprise a first electrical connection terminal disposed in the inlet pipe, and the outlet pipe may further comprise a second electrical connection terminal disposed in the outlet pipe. The first electrical connection terminal may be configured to couple to the second electrical connection terminal.

Example 28: The integrated connection device according to Example 21, wherein the outlet pipe may further comprise an electrical conductor outlet. The electrical conductor outlet may be positioned within the air cavity of the inflatable pool.

Example 29: The integrated connection device according to Example 21, wherein the outlet pipe may further comprise an electrical conductor outlet, and the electrical conductor outlet may be positioned outside of the air cavity of the inflatable pool.

Example 30: The integrated connection device according to Example 21, wherein the inlet air passageway may be fluidly isolated from the inlet electrical conductor.

Example 31: The integrated connection device according to Example 21, wherein the outlet air passageway may be fluidly isolated from the outlet electrical conductor.

Example 32: The integrated connection device according to Example 21, wherein the inlet air passageway of the inlet pipe may comprise a first inlet air passageway and a second inlet air passageway.

Example 33: The integrated connection device according to Example 32, wherein the first inlet air passageway may be in fluid communication with the air cavity of the inflatable pool, and the second inlet air passageway may be in fluid communication with the water cavity of the inflatable pool.

Example 34: The integrated connection device according to Example 21, wherein the outlet air passageway of the outlet pipe may comprise a first outlet air passageway and a second outlet air passageway.

Example 35: The integrated connection device according to Example 34, wherein the first outlet air passageway may be in fluid communication with the air cavity of the inflatable pool, and the second outlet air passageway may be in fluid communication with the water cavity of the inflatable pool.

Example 36: The integrated connection device according to Example 21, wherein the inlet air passageway of the inlet pipe may comprise a first inlet air passageway and a second inlet air passageway, and the outlet air passageway of the outlet pipe may comprise a first outlet air passageway and a second outlet air passageway, the first inlet air passageway may be in fluid communication with the first outlet air passageway, and the second inlet air passageway may be in fluid communication with the second outlet air passageway.

Example 37: The integrated connection device according to Example 36, wherein the first inlet air passageway and the first outlet air passageway may be in fluid communication with the air cavity of the inflatable pool, and the second inlet air passageway and the second outlet air passageway may be in fluid communication with the water cavity of the inflatable pool.

Example 38: An inflatable pool may comprise an inflatable body, a controller including an air pump and an electrical power supply, at least one electrically powered accessory, and a conduit connecting the controller to the inflatable body. The inflatable body may have an inner wall and an outer wall, the inner wall may bound a water cavity of the inflatable pool, and the inner wall and the outer wall may bound at least a portion of an inflatable chamber of the inflatable body. The conduit may include an air passageway coupling the air pump to the inflatable chamber of the inflatable body and an electrical conductor electrically coupling the at least one electrically powered accessory to the electrical power supply.

Example 39: The integrated connection device according to Example 38, wherein the conduit may comprise an inlet pipe, an outlet pipe, and a joint coupling the inlet pipe to the outlet pipe, the inlet pipe may comprise an inlet end coupled to an outlet of the air pump.

Example 40: The integrated connection device according to Example 39, wherein the inlet pipe may further comprise a first inlet air passageway and a second inlet air passageway, and the outlet pipe may comprise a first outlet air passageway in fluid communication with the first inlet air passageway and a second outlet air passageway in fluid communication with the second inlet air passageway, the first inlet air passageway, the second inlet air passageway, the first outlet air passageway, and the second air outlet passageway may collectively define the air passageway of the conduit.

Example 41: The integrated connection device according to Example 40, wherein the first inlet air passageway and the first air outlet passageway may be in fluid communication with the inflatable chamber of the inflatable pool, and the second inlet air passageway and the second air outlet passageway may be in fluid communication with the water cavity of the inflatable pool.

Example 42: The integrated connection device according to Example 39, wherein the inlet pipe may further comprise an inlet electrical passageway, and the outlet pipe may comprise an outlet electrical passageway, the electrical conductor passing through the inlet electrical passageway and the outlet electrical passageway.

Example 43: The integrated connection device according to any one of Examples 38-42, wherein the inlet pipe may further comprise a first electrical connection terminal disposed within the inlet pipe, and the outlet pipe may further comprise a second electrical connection terminal disposed within the outlet pipe, the first electrical connection terminal and the second electrical connection terminal may have cooperating features which may be coupled together when the inlet pipe is coupled to the outlet pipe.

Example 44: The integrated connection device according to any one of Examples 38-43, wherein the at least one electrically powered accessory may be positioned within the inflatable chamber, and the electrical conductor may be accessible from an exterior of the outlet pipe at a location within the inflatable chamber.

Example 45: The integrated connection device according to any one of Examples 38-43, wherein the at least one electrically powered accessory may be positioned external to the inflatable chamber and adjacent an exterior surface of the inflatable body, and the outlet pipe may further comprise an electrical conductor outlet positioned outside of the inflatable chamber of the inflatable body and configured to connect to the at least one electrically powered accessory.

Example 46: The integrated connection device according to Example 39, wherein the inlet pipe may further comprise a rotating component rotatably coupled to an end of the inlet pipe facing the outlet pipe, and a connecting ring configured to couple the rotating component to the inlet pipe.

Example 47: The integrated connection device according to Example 46, wherein the electrical conductor may be at least partially disposed within the rotating component.

Example 48: The integrated connection device according to Example 47, wherein the rotating component may comprise an opening configured to receive the electrical conductor.

Example 49: The integrated connection device according to Example 46, wherein the inlet pipe may further comprise a groove, and the connecting ring may comprise a block configured to be positioned within the groove of the inlet pipe, the block of the connecting ring may limit the rotation of the rotating component relative to the inlet pipe.

Example 50: The integrated connection device according to any one of Examples 38-49, wherein the at least one electrically powered accessory may be a lighting system, optionally including at least one LED strip including a plurality of LED lights.

Example 51: The integrated connection device according to Example 51, wherein the lighting system may be positioned adjacent to an exterior surface of a bottom wall of the inflatable pool and optionally received in at least one sleeve.

Example 52: The integrated connection device according to Example 51, wherein the lighting system substantially spans a perimeter of the inflatable pool.

Example 53: The integrated connection device according to Example 52, wherein the lighting system may be coupled to the bottom wall of the inflatable pool via at least one fixed piece.

Example 54: The integrated connection device according to Example 50, wherein the lighting system may be positioned within the inflatable chamber of the inflatable body.

It will be apparent to those skilled in the art that various modifications and variation can be made in the present disclosure without departing from the spirit or scope of the disclosure. Thus, it is intended that the present disclosure cover the modifications and variations of this disclosure provided they come within the scope of the appended claims and their equivalents.

1. An inflatable pool, comprising:
an inflatable pool body including:
an inner side wall,
an outer side wall disposed around the inner side wall,
a top wall connected to a top of the inner side wall and a top the outer side wall, and
a bottom wall connected to a bottom of the inner side wall and a bottom of the outer side wall;
a controller releasably coupled to the inflatable body; and
a luminous device including a luminous strip coupled to a bottom side of the bottom wall, the luminous device being coupled to the controller to receive electrical power from the controller,
wherein the bottom wall includes a light-transmitting material, and
wherein the controller includes an air pump to provide air to the inflatable body and a water pump to provide water to the inflatable body.

2. The inflatable pool of claim 1, wherein the luminous strip is disposed in a ring shape on the bottom side of the bottom wall of the inflatable pool body, the luminous strip is opposite the top wall of the inflatable pool body, and the inner side wall of the inflatable pool body includes a light-transmitting material.

3. The inflatable pool of claim 2, wherein the top wall of the inflatable pool body includes a light-transmitting material.

4. The inflatable pool of claim 2, wherein the outer side wall of the inflatable pool body includes a light-transmitting material.

5. The inflatable pool of of claim 1, wherein the bottom wall of the inflatable pool body is coupled to at least one fixing piece, and a fitting channel for housing the luminous strip is formed between the fixing piece and the bottom wall.

6. (canceled)

7. The inflatable pool of claim 6, wherein the controller includes an electrical power supply, an air pump, and an inlet pipe component, the inlet pipe component includes a first electrical connection terminal connected to the electrical power supply and an inlet air passageway connected to the air pump; the inflatable pool body includes an outlet pipe component for connecting to the inlet pipe component, the outlet pipe component includes a second electrical connection terminal electrically connected to the luminous strip and an outlet air passageway in fluid communication with an inflatable air chamber of the inflatable pool body, the second electrical connection terminal is configured to couple to the first electrical connection terminal of the inlet pipe component, and the outlet air passageway is configured to fluidly couple to the inlet air passageway.

8. The inflatable pool of claim 7, wherein the outlet pipe component is coupled to the outer side wall of the inflatable pool body.

9. The inflatable pool of claim 7, wherein the second electrical connection terminal of the outlet pipe component is electrically connected to the luminous strip via a connecting wire.

10. The inflatable pool of claim 1, wherein the luminous strip is a flexible LED strip.

11. An integrated structure for connecting an air passage and a circuit, comprising:
an outlet pipe component comprising a first face and a first air passage extending along an axis that intersects the first face, and a first electrical connection terminal positioned proximate the first face;
an inlet pipe component comprising a second face facing the first face of the outlet pipe component, a second air passage configured to fluidly connect to the first air passage of the outlet pipe component, and a second electrical connection terminal positioned proximate the second face and configured to connect to the first electrical terminal; and
a joint configured to connect the outlet pipe component to the inlet pipe component, wherein, when the joint connects the outlet pipe component to the inlet pipe component, the first air passage of the outlet pipe component and the second air passage of the inlet pipe component connect to form an air passage connection extending from the air inlet pipe component through the outlet pipe component, and the first electrical connection terminal of the outlet pipe component couples to the second electrical connection terminal of the inlet pipe component to form an electrical connection therewith.

12. The integrated structure according to claim 11, wherein the joint comprises threads and is sleeved at an end of the inlet pipe component facing the outlet pipe component, and an outer wall of the outlet pipe component is externally threaded and configured to threadably engage with the threads of the joint.

13. The integrated structure according to claim 12, wherein the second electrical connection terminal of the inlet pipe component is a power female connector and the first electrical connection terminal of the outlet pipe component is a power male connector.

14. The integrated structure according to claim 13, wherein the inlet pipe component further comprises an inlet air pipe, a rotating component, and a connecting ring, and the rotating component is rotatably connected to the end of the inlet pipe facing the outlet pipe component through the connecting ring.

15. The integrated structure according to claim 14, wherein an outer wall of the inlet pipe is provided with a limit groove extending partially along the circumference of the outer wall, the connecting ring comprises a clamp block that fits within the limit groove, and the limit groove is limits the rotation range of the clamp block.

16. The integrated structure according to claim 15, wherein the connecting ring is divided into a semicircular first connecting ring comprising a first clamp block and semicircular second connecting ring comprising a second clamp block; the first connecting ring and the second connecting ring are connected to form a clamping space for clamping the inlet pipe.

17. The integrated structure according to claim 16, further comprising at least one limit groove, the limit groove is rotatably matched with the first clamping block of the first connecting ring and the second clamping block of the second connecting ring.

18. An air pump comprising an air pump body and the integrated structure according to claim 11.

19. A swimming pool comprising the air pump according to claim 18.

20. The swimming pool according to claim 19, wherein the swimming pool is a SPA swimming pool.

21. An integrated connection device configured to connect a controller to an inflatable pool having an air cavity and a water cavity, the integrated connection device comprising:
an inlet pipe coupled to the controller and comprising an inlet air passageway and an inlet electrical conductor positioned at least partially within the inlet pipe,
an outlet pipe including a portion positioned between the inlet pipe and the inflatable pool, the outlet pipe comprising an outlet air passageway and an outlet electrical conductor positioned at least partially within the outlet pipe, and
a joint configured to couple the inlet pipe to the outlet pipe, the inlet air passageway being coupled to the outlet air passageway when the joint couples the inlet pipe to the outlet pipe.

22. The integrated connection device of claim 21, wherein the inlet electrical conductor is electrically coupled to the outlet electrical conductor when the joint couples the inlet pipe to the outlet pipe.

23. The integrated connection device of claim 21, wherein the inlet pipe further comprises a rotating component rotatably coupled to an end of the inlet pipe facing the outlet pipe, and a connecting ring configured to couple the rotating component to the inlet pipe.

24. The integrated connection device of claim 23, wherein a first end of the inlet electrical conductor is accessible from an exterior of the rotating component.

25. The integrated connection device of claim 23, wherein the rotating component comprises a portion of the inlet air passageway of the inlet pipe and a separate electrical passageway which receives the electrical conductor.

26. The integrated connection device of claim 23, wherein the inlet pipe further comprises a groove, and wherein the connecting ring comprises a block configured to be positioned within the groove of the inlet pipe, the block of the connecting ring limiting the rotation of the rotating component relative to the inlet pipe.

27. The integrated connection device of claim 21, wherein the inlet pipe further comprises a first electrical connection terminal disposed within the inlet pipe, and wherein the outlet pipe further comprises a second electrical connection terminal disposed within the outlet pipe, the first electrical connection terminal configured to couple to the second electrical connection terminal.

28. The integrated connection device of claim 21, wherein the outlet pipe further comprises an electrical conductor outlet, the electrical conductor outlet positioned within the air cavity of the inflatable pool.

29. The integrated connection device of claim 21, wherein the outlet pipe further comprises an electrical conductor outlet, the electrical conductor outlet positioned outside of the air cavity of the inflatable pool.

30. The integrated connection device of claim 21, wherein the inlet air passageway is fluidly isolated from the inlet electrical conductor.

31. The integrated connection device of claim 21, wherein the outlet air passageway is fluidly isolated from the outlet electrical conductor.

32. The integrated connection device of claim 21, wherein the inlet air passageway of the inlet pipe comprises a first inlet air passageway and a second inlet air passageway.

33. The integrated connection device of claim 32, wherein the first inlet air passageway is in fluid communication with the air cavity of the inflatable pool, and wherein the second inlet air passageway is in fluid communication with the water cavity of the inflatable pool.

34. The integrated connection device of claim 21, wherein the outlet air passageway of the outlet pipe comprises a first outlet air passageway and a second outlet air passageway.

35. The integrated connection device of claim 34, wherein the first outlet air passageway is in fluid communication with the air cavity of the inflatable pool, and wherein the second outlet air passageway is in fluid communication with the water cavity of the inflatable pool.

36. The integrated connection device of claim 21, wherein the inlet air passageway of the inlet pipe comprises a first inlet air passageway and a second inlet air passageway, wherein the outlet air passageway of the outlet pipe comprises a first outlet air passageway and a second outlet air passageway, the first inlet air passageway in fluid communication with the first outlet air passageway, and the second inlet air passageway in fluid communication with the second outlet air passageway.

37. The integrated connection device of claim 36, wherein the first inlet air passageway and the first outlet air passageway are in fluid communication with the air cavity of the inflatable pool, and wherein the second inlet air passageway and the second outlet air passageway are in fluid communication with the water cavity of the inflatable pool.

38. An inflatable pool, the inflatable pool comprising:
an inflatable body having an inner wall and an outer wall, the inner wall bounding a water cavity of the inflatable pool and the inner wall and the outer wall bounding at least a portion of an inflatable chamber of the inflatable body;
a controller including an air pump and an electrical power supply;
at least one electrically powered accessory; and
a conduit connecting the controller to the inflatable body, the conduit including an air passageway coupling the air pump to the inflatable chamber of the inflatable body and an electrical conductor electrically coupling the at least one electrically powered accessory to the electrical power supply.

39. The inflatable pool of claim 38, wherein the conduit comprises an inlet pipe, an outlet pipe, and a joint coupling the inlet pipe to the outlet pipe, the inlet pipe comprising an inlet end coupled to an outlet of the air pump.

40. The inflatable pool of claim 39, wherein the inlet pipe further comprises a first inlet air passageway and a second inlet air passageway, and wherein the outlet pipe comprises a first outlet air passageway in fluid communication with the first inlet air passageway and a second outlet air passageway in fluid communication with the second inlet air passageway, the first inlet air passageway, the second inlet air passageway, the first outlet air passageway, and the second air outlet passageway collectively defining the air passageway of the conduit.

41. The inflatable pool of claim 40, wherein the first inlet air passageway and the first air outlet passageway are in fluid communication with the inflatable chamber of the inflatable pool, and wherein the second inlet air passageway and the second air outlet passageway are in fluid communication with the water cavity of the inflatable pool.

42. The inflatable pool of claim 39, wherein the inlet pipe further comprises an inlet electrical passageway, and wherein the outlet pipe comprises an outlet electrical passageway, the electrical conductor passing through the inlet electrical passageway and the outlet electrical passageway.

43. The inflatable pool of claim 38, wherein the inlet pipe further comprises a first electrical connection terminal disposed within the inlet pipe, and wherein the outlet pipe further comprises a second electrical connection terminal disposed within the outlet pipe, the first electrical connection terminal and the second electrical connection terminal having cooperating features which are coupled together when the inlet pipe is coupled to the outlet pipe.

44. The inflatable pool of claim 38 wherein the at least one electrically powered accessory is positioned within the inflatable chamber, the electrical conductor being accessible from an exterior of the outlet pipe at a location within the inflatable chamber.

45. The inflatable pool of claim 38, wherein the at least one electrically powered accessory is positioned external to the inflatable chamber and adjacent an exterior surface of the inflatable body, and wherein the outlet pipe further comprises an electrical conductor outlet positioned outside of the inflatable chamber of the inflatable body and configured to connect to the at least one electrically powered accessory.

46. The inflatable pool of claim 39, wherein the inlet pipe further comprises a rotating component rotatably coupled to an end of the inlet pipe facing the outlet pipe, and a connecting ring configured to couple the rotating component to the inlet pipe.

47. The inflatable pool of claim 46, wherein electrical conductor is at least partially disposed within the rotating component.

48. The inflatable pool of claim 47, wherein the rotating component comprises an opening configured to receive the electrical conductor.

49. The inflatable pool of claim 46, wherein the inlet pipe further comprises a groove, and wherein the connecting ring comprises a block configured to be positioned within the groove of the inlet pipe, the block of the connecting ring limiting the rotation of the rotating component relative to the inlet pipe.

50. The inflatable pool of claim 38, wherein the at least one electrically powered accessory is a lighting system, optionally including at least one LED strip including a plurality of LED lights.

51. The inflatable pool of claim 50, wherein the lighting system is positioned adjacent an exterior surface of a bottom wall of the inflatable pool and optionally received in at least one sleeve.

52. The inflatable pool of claim 51, wherein the lighting system substantially spans a perimeter of the inflatable pool.

53. The inflatable pool of claim 52, wherein the lighting system is coupled to the bottom wall of the inflatable pool via at least one fixed piece.

54. The inflatable pool of claim 50, wherein the lighting system is positioned within the inflatable chamber of the inflatable body.
